(19) United States
(12) Patent Application Publication
(10) Pub. No.: US 2012/0019071 A1
(43) Pub. Date: Jan. 26, 2012

(54) BACKUP POWER SYSTEM WITH FUEL CELL AND CONTROL METHOD THEREOF

(75) Inventors: Zhan-Yi Lin, Kwei Shan Township (TW); Jin-Ming Chang, Kwei Shan Township (TW); To-Wei Huang, Kwei Shan Township (TW); Yu-Ming Sun, Kwei Shan Township (TW); Chi-Bin Wu, Kwei Shan Township (TW)

(73) Assignee: Chung-Hsin Electric and Machinery Manufacturing Corp., Jhonghe City (TW)

(21) Appl. No.: 12/915,558

(22) Filed: Oct. 29, 2010

(30) Foreign Application Priority Data
Jul. 23, 2010 (TW) 099124431

(51) Int. Cl. H02J 9/06

(52) U.S. Cl. 307/65

(57) ABSTRACT

A backup power system with a fuel cell and a control method thereof are provided. The control method includes the steps of: setting a default variation value; determining whether power interruption has happened to a grid power module; determining whether a load is functioning; performing a limiting step; and controlling the output of a fuel cell system. With the control method, the fuel cell system functions as a backup power system configured for grid power, and the fuel cell system generates power in response to variation of the load.

### BACKGROUND OF THE INVENTION

1. Technical Field

The present invention relates to backup power systems with fuel cells and control methods thereof. More particularly, the present invention relates to a backup power system with a fuel cell and a control method for enabling a fuel cell system of the backup power system to respond to variation of a load in real time.

2. Description of Related Art

A backup power system (BPS) is a standby power supply system widely used in medical service institutions and high-tech plants that require high-quality electric power. When grid power is interrupted, a conventional backup power system usually resorts to a storage battery for power supply, and the duration of buffer provided by the storage battery depends on the capacity of the storage battery. Therefore, for those who demand not only stable but also high-capacity electric power supply, the conventional backup power system fails to meet their needs.

In view of the aforesaid drawbacks of the prior art, fuel cell systems are nowadays configured to function as backup power systems for grid power sources. Presently, fuel cell systems are regarded as the mainstream of energy source devices for the following reasons. Firstly, given a continuous supply of fuel, a fuel cell system can generate electric power continuously. Secondly, compared with storage batteries, fuel cell systems are much more efficient and environmentally friendly.

However, fuel cell systems take too long to respond. Once a load begins to vary, a fuel cell system will usually take a while to respond to the variation of the load. In the face of load variation, a fuel cell-based backup power system has to load or load-shed the fuel cell system right away, but doing so brings about disadvantageous consequences, such as shortening the service life of the fuel cell system, increasing the chance of damage, and hence incurring costs to the backup power system.

### BRIEF SUMMARY OF THE INVENTION

The present invention relates to a backup power system with a fuel cell and a control method thereof, wherein a fuel cell system functions as the main power source for the backup power system.

The present invention relates to a backup power system with a fuel cell and a control method thereof, wherein the control method enables a fuel cell system to overcome the problem of having a long response time and, with the assistance of a storage battery, enables the fuel cell system to respond in real time to the variation of a load in terms of power demand.

The present invention relates to a backup power system with a fuel cell and a control method thereof, wherein the control method ensures that the service life of a fuel cell system will not be shorten by quickly loading or load-shedding the fuel cell system.

In order to achieve the above and other objectives, the present invention provides a backup power system with a fuel cell. The backup power system comprises: a grid power module for receiving a grid power source and converting the grid power source so as to provide direct current power; the backup power system comprising: a fuel cell system having a first output end; a power regulating module having a second input end and a second output end, the second input end being electrically connected to the first output end; and a storage battery parallel-connected to the second output end; and a selecting switch selectively electrically connected to the grid power module and the backup power system, wherein, upon interruption of the direct current power, the selecting switch is electrically connected to the backup power system so that, when the fuel cell system has a lower voltage than the storage battery, it is the storage battery that supplies power, and when the fuel cell system has a higher voltage than the storage battery, it is the fuel cell system that supplies most of the required power.

In order to achieve the above and other objectives, the present invention further provides a control method for use with a backup power system with a fuel cell. The control method comprises the steps of: setting a default variation value, wherein the default variation value is a critical value of variation of a load, and the critical value of variation of the load is acceptable by a power regulating module; determining whether power interruption has happened to a grid power module; determining whether the load is functioning, wherein a selecting switch is switched to the backup power system and is thereby electrically connected thereto when it is determined that the load is functioning and that power interruption has happened to the grid power module; performing a limiting step, wherein the power regulating module stops a fuel cell system from outputting power, allows a storage battery to supply power to the load, and allows the fuel cell system to output power only after the fuel cell system is loaded to a level sufficient to supply the amount of power required by the load; and controlling an output of the fuel cell system, wherein the power regulating module controls the output of the fuel cell system such that an output of the backup power system responds to variation of the load in real time.

Implementation of the present invention at least involves the inventive steps of:

1. enabling a fuel cell system to serve as the main power source for a backup power system; and

2. enabling the fuel cell system to respond to variation of a load in real time.

The features and advantages of the present invention are described hereinafter in detail with reference to the preferred embodiments of the present invention. The detailed description is intended to enable a person skilled in the art to gain insight into the technical contents disclosed herein and implement the present invention accordingly. A person skilled in the art can easily understand the objectives and advantages of the present invention by referring to the disclosure of the specification, the claims, and the accompanying drawings.

### BRIEF DESCRIPTION OF THE SEVERAL VIEWS OF THE DRAWINGS

FIG. 1 schematically shows the framework of a backup power system with a fuel cell in an embodiment according to the present invention;

FIG. 2 is a detailed flowchart of a control method of a backup power system with a fuel cell in an embodiment according to the present invention;

FIG. 3 is a schematic flowchart of the control method illustrated in FIG. 2;

FIG. 4 is a schematic flowchart of a limiting step in an embodiment according to the present invention;

FIG. 5 is a schematic flowchart of a step for controlling an output of a fuel cell system in an embodiment according to the present invention;

FIG. 6 is a schematic flowchart of a controlling step in an embodiment according to the present invention;

FIG. 7 is a schematic flowchart of a monitoring step in an embodiment according to the present invention; and

FIG. 8 is a schematic flowchart of a sub-step of comparing an actuation time with a response time in the monitoring step illustrated in FIG. 7.

### DETAILED DESCRIPTION OF THE INVENTION

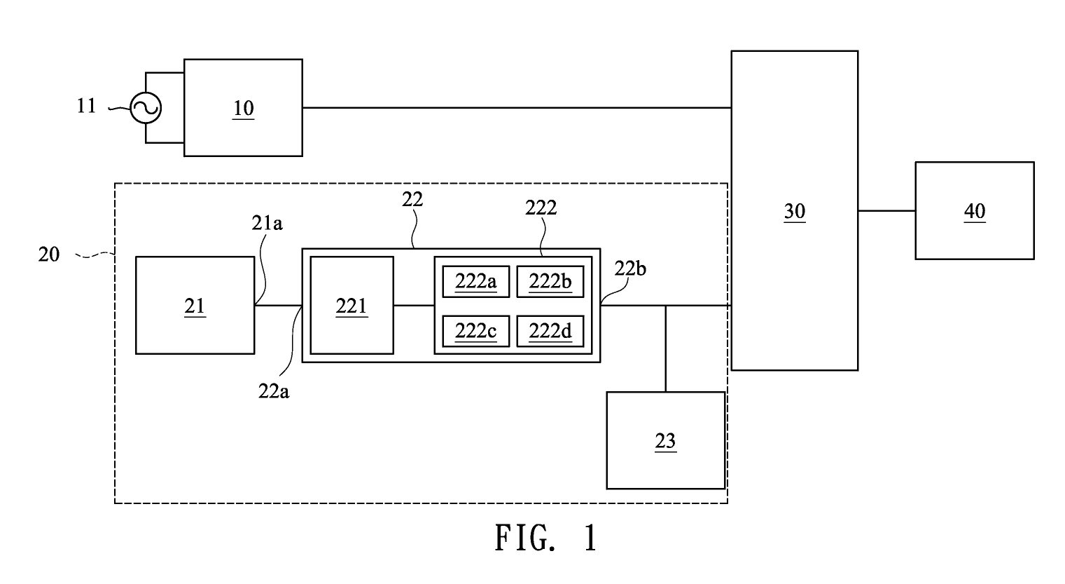

Referring to FIG. 1, in an embodiment of the present invention, a backup power system 20 with a fuel cell comprises a grid power module 10, the backup power system 20, and a selecting switch 30.

The grid power module 10 receives a grid power source 11 and converts the grid power source 11 so as to provide direct current (DC) power that functions as the main power source for a load 40. When power interruption happens to the grid power source 11, the backup power system 20 is started and functions as a backup power source for the load 40, thereby ensuring continuous power supply to the load 40.

The backup power system 20 comprises a fuel cell system 21, a power regulating module 22, and a storage battery 23. The fuel cell system 21 serves as one of the power sources of the backup power system 20 and has a first output end 21a.

The power regulating module 22 has a second input end 22a and a second output end 22b. The second input end 22a of the power regulating module 22 is electrically connected to the first output end 21a of the fuel cell system 21. The power regulating module 22 is configured to regulate and control the power output from the fuel cell system 21. More specifically, since the power output from the fuel cell system 21 does not vary with variation of the load 40 flexibly and freely, the power regulating module 22 serves to control the power output from the fuel cell system 21. The power regulating module 22 calculates a response time in order to obtain the buffer time required for the fuel cell system 21 to boost its own voltage. It is only after the response time has elapsed that the fuel cell system 21 is loaded. The purpose of the aforesaid design is to ensure that the actual service life of the fuel cell system 21 will be as long as expected.

The power regulating module 22 further comprises a switched-mode power converter 221 and a controller 222. The switched-mode power converter 221 converts the power generated by the fuel cell system 21 into the direct current power required by the load 40. The controller 222 is electrically connected to the switched-mode power converter 221 to control the actuation of the switched-mode power converter 221. The controller 222 comprises a controlling unit 222a, a counter 222b, a computing unit 222c, and a register 222d.

The storage battery 23 is parallel-connected to the second output end 22b of the power regulating module 22 and serves as another power source for the backup power system 20. The storage battery 23 supplies power to the load 40 provided that a surge of power demand from the load 40 occurs and that the fuel cell system 21 is waiting the response time to elapse so as to be loaded.

The selecting switch 30 is selectively electrically connected to the grid power module 10 and the backup power system 20. Upon interruption of the direct current power of the grid power module 10, the selecting switch 30 is switched to the backup power system 20 and is thereby electrically connected thereto, so as for the backup power system 20 to function as the power source of the load 40. More particularly, when the voltage of the fuel cell system 21 of the backup power system 20 is lower than that of the storage battery 23, it is the storage battery 23 that supplies power; and when the voltage of the fuel cell system 21 is higher than that of the storage battery 23, it is the fuel cell system 21 that supplies most of the required power.

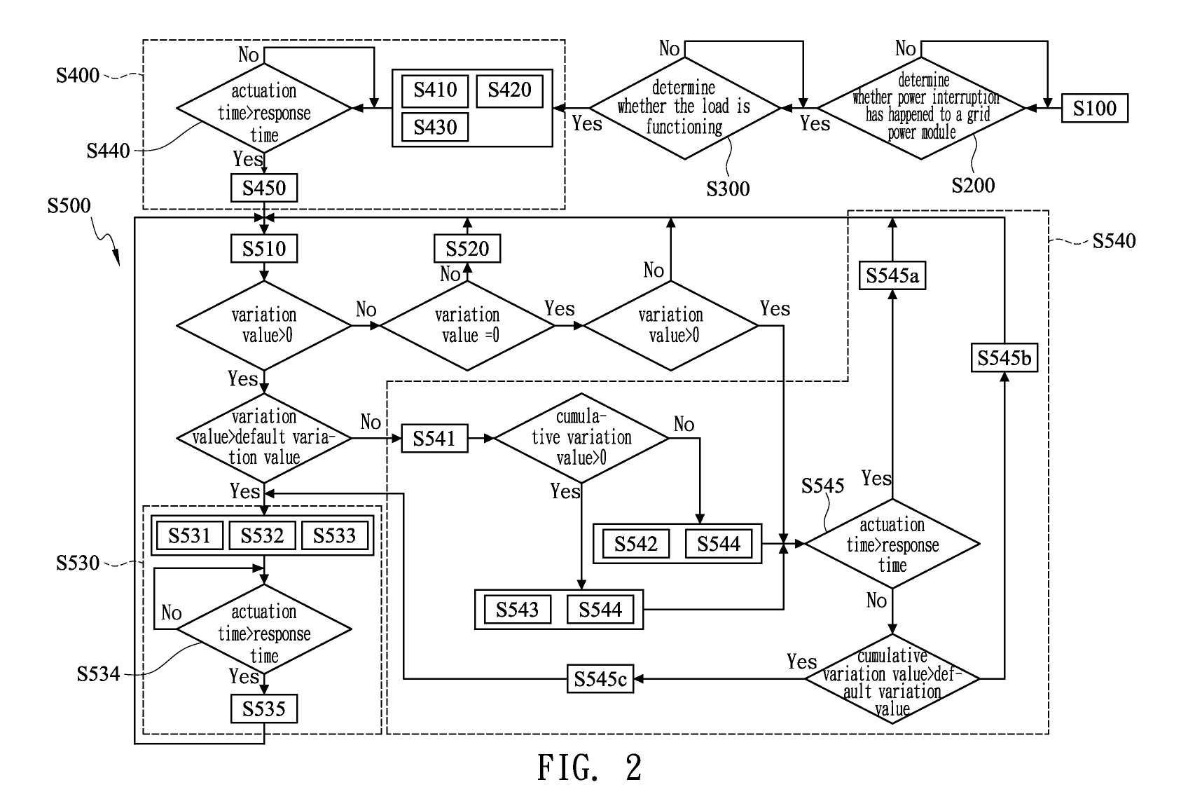

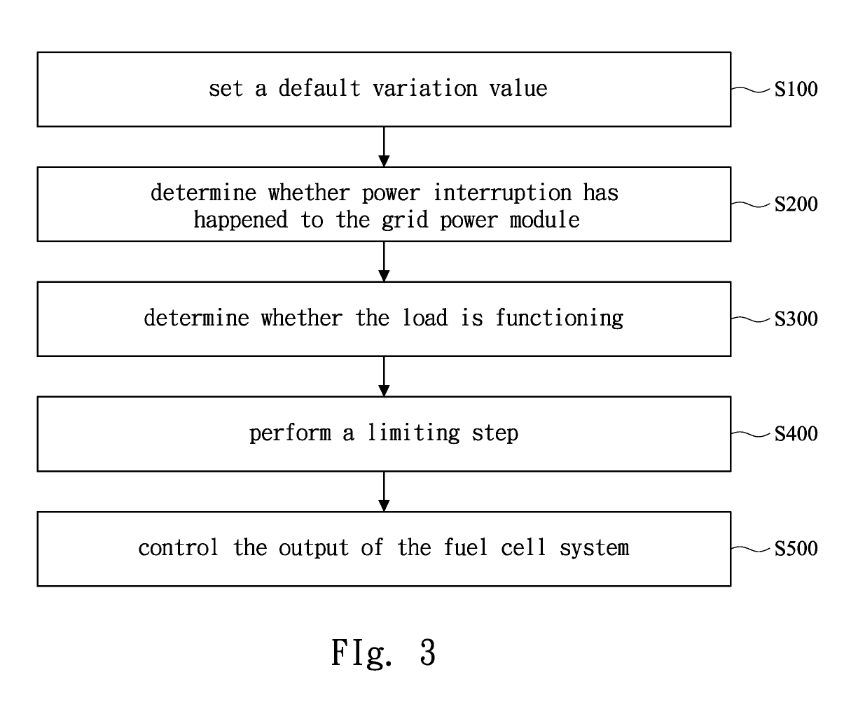

Referring to FIG. 2 and FIG. 3, a control method for use with the foregoing backup power system 20 with a fuel cell comprises the steps of: setting a default variation value (S100); determining whether power interruption has happened to the grid power module (S200); determining whether the load is functioning (S300); performing a limiting step (S400); and controlling the output of the fuel cell system (S500).

Setting a default variation value (S100): The default variation value is defined as a critical value of variation of the load 40, wherein the critical value of variation of the load 40 is acceptable by the power regulating module 22. The fuel cell system 21 can respond to the variation of the load 40 in real time and supply power to the load 40 if the variation of the load 40 does not exceed the default variation value. Conversely, in a situation where the variation of the load 40 exceeds the default variation value, the fuel cell system 21 cannot generate the power required by the load 40 until a certain response time has elapsed.

Determining whether power interruption has happened to the grid power module (S200): Whether or not the grid power module 10 is still supplying power continuously can be determined by receiving a feedback signal from the load 40.

Determining whether the load is functioning (S300): With the load 40 in operation and the grid power module 10 experiencing power interruption, the selecting switch 30 is switched to the backup power system 20 and thus electrically connected thereto such that the backup power system 20 functions as the power source.

Performing a limiting step (S400): The power regulating module 22 performs the limiting step and controls the power output from the fuel cell system 21, so as not to damage the fuel cell system 21 and undesirably shorten the service life thereof by loading the fuel cell system 21 quickly. More specifically, as soon as the selecting switch 30 is switched to the backup power system 20, the power regulating module 22 stops the fuel cell system 21 from outputting power but allows the storage battery 23 to supply power to the load 40. It is only after the fuel cell system 21 has been loaded to the level sufficient to supply the amount of power required by the load 40 that the fuel cell system 21 begins to output power through the power regulating module 22.

Controlling the output of the fuel cell system (S500): Once the fuel cell system 21 begins to output power through the power regulating module 22, the power regulating module 22 controls the power output from the fuel cell system 21 and, working in conjunction with the storage battery 23, enables the output of the backup power system 20 to respond to the variation of the load 40 in real time.

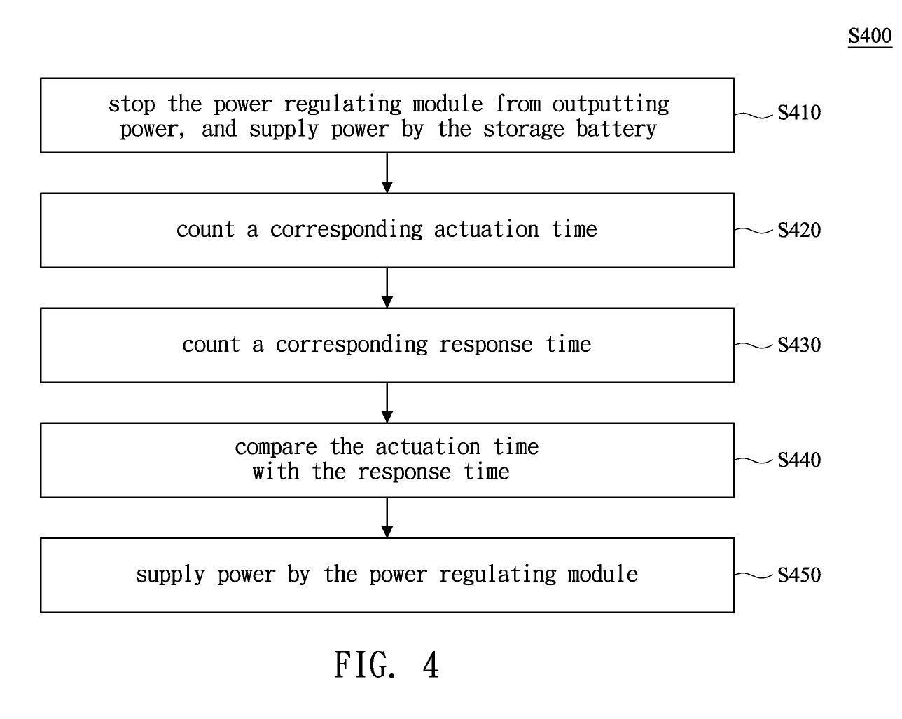

Referring to FIG. 4, the limiting step (S400) is performed by the controller 222 and comprises the sub-steps of: stopping the power regulating module from outputting power, and supplying power by the storage battery (S410); counting a corresponding actuation time (S420); computing a corresponding response time (S430); comparing the actuation time with the response time (S440); and supplying power by the power regulating module (S450).

Stopping the power regulating module from outputting power, and supplying power by the storage battery (S410): In the initial state where the selecting switch 30 is just switched to the backup power system 20, the fuel cell system 21 is about to be started and hence unprepared for an instantaneous boost of power to that required by the load 40. Therefore, the controller 222 of the power regulating module 22 stops the fuel cell system 21 from outputting electric power. Meanwhile, as the voltage of the fuel cell system 21 is lower than that of the storage battery 23 parallel-connected to the power regulating module 22, the storage battery 23 is responsible for supplying power to the load 40.

Counting a corresponding actuation time (S420): The counter 222b of the controller 222 counts the actuation time of the power regulating module 22.

Computing a corresponding response time (S430): The computing unit 222c of the controller 222 computes the response time corresponding to a variation value. In other words, the computing unit 222c calculates the response time required by the fuel cell system 21 by making reference to the variation value of the load 40, wherein the variation value is defined as the variation percentage of the load 40.

Comparing the actuation time with the response time (S440): Once the actuation time counted by the counter 222b, the response time calculated by the computing unit 222c, and the variation value of the load 40 are temporarily stored in the register 222d, the controlling unit 222a compares the actuation time with the response time.

Supplying power by the power regulating module (S450): If the actuation time is longer than the response time, meaning that the response time required for boosting the power capacity of the fuel cell system 21 has elapsed, the power regulating module 22 will actuate the loading operation; as a result, the fuel cell system 21 outputs power through the power regulating module 22. Conversely, if the actuation time is less than the response time, meaning that the required response time of the fuel cell system 21 has not elapsed, the power regulating module 22 will not and cannot actuate the loading operation.

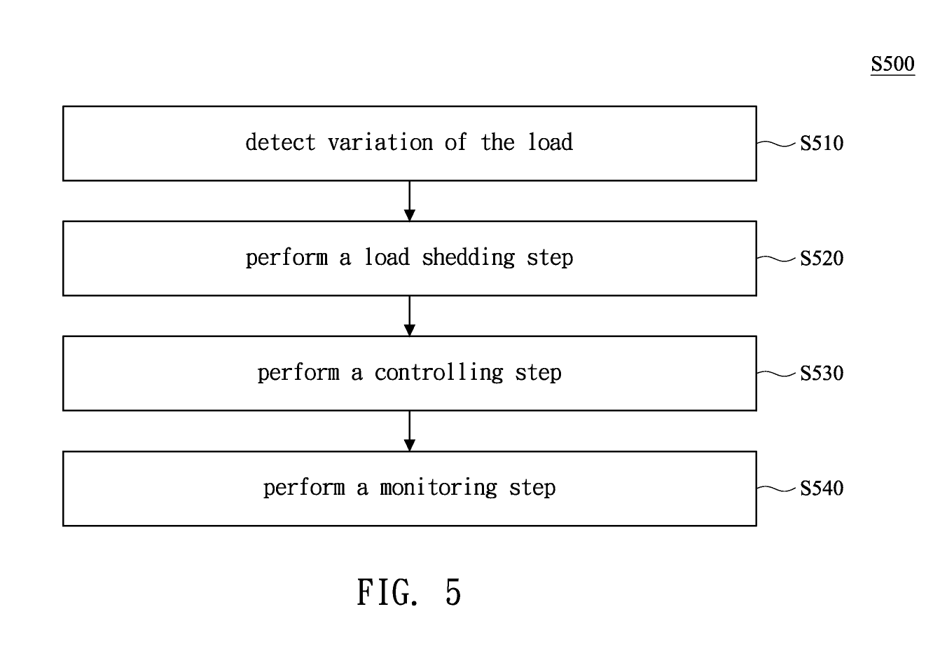

Referring to FIG. 5, the step of controlling the output of the fuel cell system (S500) comprises the sub-steps of: detecting variation of the load (S510); performing a load shedding step (S520); performing a controlling step (S530); and performing a monitoring step (S540).

Detecting variation of the load (S510): The controlling unit 222a in the controller 222 can detect the variation of the load 40 and obtain the variation value of the load 40 by means of a feedback signal.

Referring to FIG. 2 again, after the variation value is obtained, it is necessary to determine whether the variation value is larger than zero. A variation value of zero indicates that the power requirement of the load 40 in unchanged and that it suffices for the fuel cell system 21 to maintain the existing output. On the other hand, if the variation value is less than zero, the controlling unit 222a performs the load shedding step (S520). If the variation value is larger than zero, it is necessary to further determine whether the variation value is larger than the default variation value. If the variation value is larger than the default variation value, the controlling step (S530) will be performed; if the variation value is less than or equal to the default variation value, the monitoring step (S540) will be performed.

Performing a load shedding step (S520): In case of a reduction in the power requirement of the load 40 (i.e., when the variation value is less than zero), no response time is required for the fuel cell system 21, for the fuel cell system 21 can be load-shed right away to output the required power.

Performing a controlling step (S530): When the variation value of the load 40 is larger than the preset default variation value, meaning that the power currently generated by the fuel cell system 21 is insufficient for the load 40, the controlling step is performed as follows. On one hand, the power regulating module 22 maintains the output power of the fuel cell system 21; on the other hand, the storage battery 23 supplies power in an auxiliary manner. Thus, the fuel cell system 21 is prevented from being overloaded.

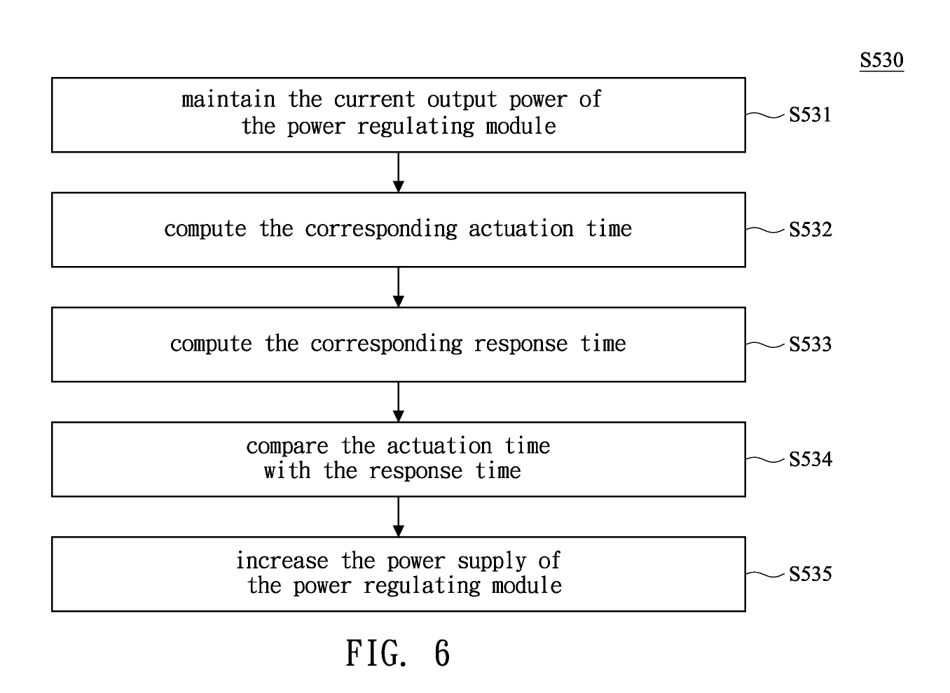

Referring to FIG. 6, the controlling step (S530) is performed by the controller 222 and comprises the sub-steps of: maintaining the current output power of the power regulating module (S531); counting the corresponding actuation time (S532); computing the corresponding response time (S533); comparing the actuation time with the response time (S534); and increasing the power supply of the power regulating module (S535).

Maintaining the current output power of the power regulating module (S531): When the variation value of the load 40 is larger than the default variation value, the power regulating module 22 maintains the existing output power of the fuel cell system 21. Meanwhile, the storage battery 23 supplies power to the load 40 in an auxiliary manner so as to meet the power requirement for boosting the voltage of the load 40.

Counting the corresponding actuation time (S532): The counter 222b of the controller 222 counts the actuation time of the power regulating module 22.

Computing the corresponding response time (S533): According to the variation value of the load 40, the computing unit 222c computes the response time required by the fuel cell system 21.

Comparing the actuation time with the response time (S534): Once the actuation time counted by the counter 222b, the response time computed by the computing unit 222c, and the variation value of the load 40 are temporarily stored in the register 222d, the actuation time and the response time are compared by means of the controlling unit 222a.

Increasing the power supply of the power regulating module (S535): If the actuation time is longer than the response time, meaning that the fuel cell system 21 is now capable of supplying enough power to cope with the variation of the load 40, the fuel cell system 21 will output the power required by the load 40 through the power regulating module 22. Conversely, if the actuation time is still shorter than the response time, the controlling unit 222a will continue comparing the actuation time with the response time. Only when the controlling unit 222a finds the actuation time longer than the response time will the boosting of the power supply of the power regulating module 22 begin.

After the power regulating module 22 has output the power required by the load 40, the counter 222b stops counting, and the data in the register 222d are deleted, thereby finalizing a single instance of the controlling step. Following that, the step of controlling the output of the fuel cell system (S500) is performed, which involves detecting the variation of the load 40 and responding to the variation of the load 40.

Performing a monitoring step (S540): In a general setting, if the variation value of the load 40 is less than the default variation value, the fuel cell system 21 can begin supplying power without having to wait for the expiration of the response time. Nonetheless, it is possible for the sum of the variation values of multiple instances of small variation to exceed the default variation value, wherein small variation refers to any variation of the load 40 that has a variation value less than the default variation value. As any instance of small variation will not trigger the execution of the controlling step, and consequently the power regulating module 22 will not control the loading of the fuel cell system 21 in response to any such instance, there is a possibility of overloading the fuel cell system 21 after multiple instances of small variation. Hence, the monitoring step (S540) is designed to prevent the cumulative variation value from exceeding the default variation value despite multiple instances of small variation of the load 40.

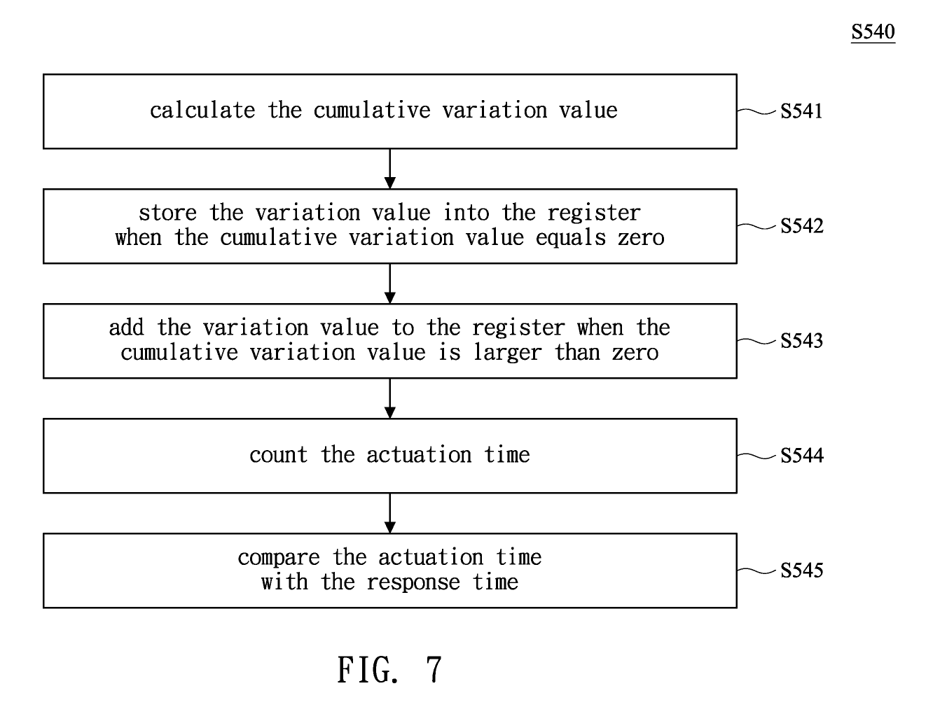

Referring to FIG. 7, the monitoring step (S540) is performed by the controller 222 and comprises the sub-steps of: calculating the cumulative variation value (S541); storing the variation value into the register when the cumulative variation value equals zero (S542); adding the variation value to the register when the cumulative variation value is larger than zero (S543); counting the actuation time (S544); and comparing the actuation time with the response time (S545).

Calculating the cumulative variation value (S541): To prevent the sum of variation values from exceeding the default variation value after multiple instances of small variation of the load 40, a cumulative variation value is defined as the cumulative variation percentage of the load 40 and is obtained by storing or adding up the variation value each time the monitoring step is performed.

Storing the variation value into the register when the cumulative variation value equals zero (S542): Confirmation of the cumulative variation value as zero is followed by: storing the variation value into the register 222d, calculating the response time corresponding to the variation value, and storing both the variation value and the response time into the register 222d.

Since the variation value of the load 40 is currently not larger than the default variation value, the power regulating module 22 can output power according to the power requirement of the load 40.

Adding the variation value to the register when the cumulative variation value is larger than zero (S543): If the cumulative variation value is larger than zero, i.e., when there have been multiple instances of small variation of the load 40, the variation value will be added to the register 222d to update the cumulative variation value. Then, the controller 222 calculates the response time corresponding to the cumulative variation value and stores the cumulative variation value and the response time thus calculated into the register 222d, thereby overwriting the old data in the register 222d.

Counting the actuation time (S544): The counter 222b of the controller 222 counts the actuation time of the power regulating module 22.

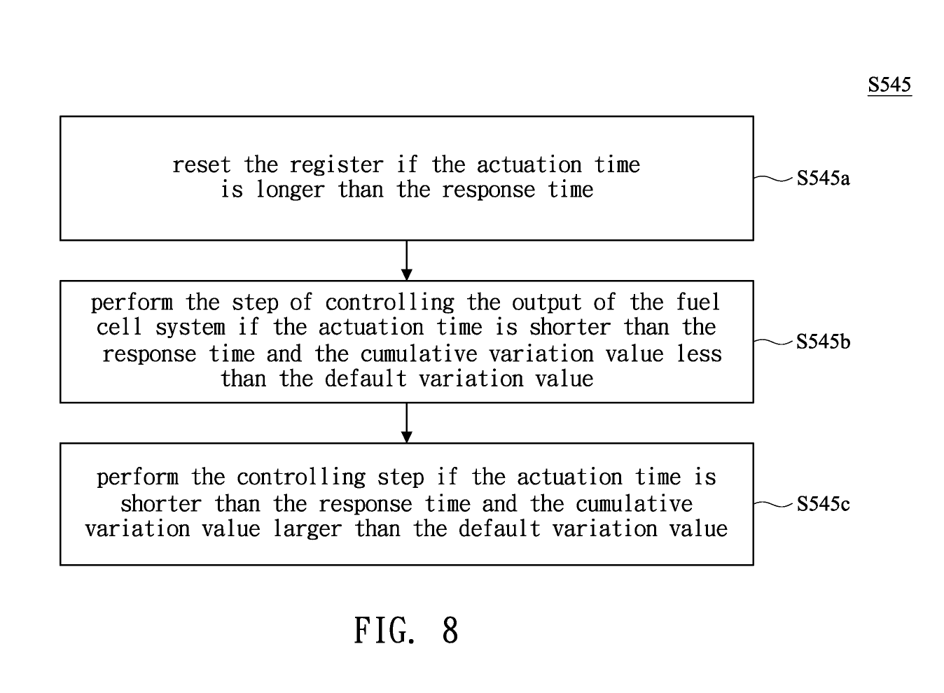

Comparing the actuation time with the response time (S545): Referring to FIG. 8, a comparison between the actuation time and the response time is followed by: resetting the register if the actuation time is longer than the response time (S545a); performing the step of controlling the output of the fuel cell system if the actuation time is shorter than the response time and the cumulative variation value less than the default variation value (S545b); and performing the controlling step if the actuation time is shorter than the response time and the cumulative variation value larger than the default variation value (S545c).

Resetting the register if the actuation time is longer than the response time (S545a): If the actuation time is longer than the response time, the fuel cell system 21 has had sufficient time to boost its power to cope with the variation of the load 40. Under such condition, the fuel cell system 21 is unlikely to be quickly loaded, whether the cumulative variation value is larger than the default variation value or not. Therefore, the register 222d is rest, and the step of controlling the output of the fuel cell system (S500) follows.

Performing the step of controlling the output of the fuel cell system if the actuation time is less than the response time and the cumulative variation value less than the default variation value (S545b): The load 40 may vary so rapidly that, before the actuation time of the power regulating module 22 reaches the response time, an additional instance of variation of the load 40 occurs and results in another response time to be reached by the actuation time. However, as long as the cumulative variation value is still less than the default variation value, it will be unnecessary to restrict the output power of the fuel cell system 21, and the step of controlling the output of the fuel cell system (S500) can be performed.

Furthermore, while the cumulative variation value remains in the register 222d, and the load 40 stays unchanged, the counter 222b keeps counting until the actuation time is larger than the response time corresponding to the cumulative variation value. Once the actuation time becomes larger than the response time, the register 222d can be reset, and the step of controlling the output of the fuel cell system (S500) performed.

Performing the controlling step if the actuation time is shorter than the response time and the cumulative variation value larger than the default variation value (S545c): If the actuation time is shorter than the response time and the cumulative variation value is larger than the default variation value after a plurality of instances of summation, the fuel cell system 21 is likely to be overloaded. Hence, the controlling step (S530) is performed to maintain the current output power of the power regulating module 22, and the storage battery 23 supplies power to the load 40 in an auxiliary manner, thereby preventing the fuel cell system 21 from damage which may otherwise result from overload. Meanwhile, the counter 222b stops counting, and the data in the register 222d are deleted. The computing unit 222c then computes the difference between the response time and the actuation time. The difference thus obtained is temporarily stored in the register 222d and replaces the response time in the controlling step (S530).

By implementation of the aforesaid steps and sub-steps, the power regulating module 22 ensures that the fuel cell system 21 will not be instantly loaded during the response time corresponding to the default variation value, thereby protecting the fuel cell system 21 against damage. The concurrent use of the backup power system 20 and the storage battery 23 is efficient because, whenever the fuel cell system 21 cannot be instantly loaded, the storage battery 23 can support the power requirement of the load 40, thus allowing the output of the backup power system 20 to respond to the variation of the load 40 in real time.

The embodiments described above serve to demonstrate the features of the present invention so that a person skilled in the art can understand the contents disclosed herein and implement the present invention accordingly. The embodiments, however, are not intended to limit the scope of the present invention. Therefore, all equivalent changes or modifications which do not depart from the spirit of the present invention should fall within the scope of the present invention, which is defined only by the appended claims.

What is claimed is:

1. A backup power system with a fuel cell, the backup power system comprising:
a grid power module for receiving a grid power source and converting the grid power source so as to provide direct current (DC) power;
the backup power system comprising:
a fuel cell system having a first output end;
a power regulating module having a second input end and a second output end, the second input end being electrically connected to the first output end; and
a storage battery parallel-connected to the second output end; and
a selecting switch selectively electrically connected to the grid power module and the backup power system;
wherein, upon interruption of the direct current power, the selecting switch is electrically connected to the backup power system so that, when the fuel cell system has a lower voltage than the storage battery, it is the storage battery that supplies power, and when the fuel cell system has a higher voltage than the storage battery, it is the fuel cell system that supplies main power.

2. The backup power system of claim 1, wherein the power regulating module comprises a switched-mode power converter and a controller for controlling the switched-mode power converter.

3. A control method for use with the backup power system of claim 1, comprising the steps of:
setting a default variation value, wherein the default variation value is a critical value of variation of a load, and the critical value of variation of the load is acceptable by the power regulating module;
determining whether power interruption has happened to the grid power module;
determining whether the load is functioning, wherein the selecting switch is switched to the backup power system and thus electrically connected thereto if it is determined that the load is functioning and that power interruption has happened to the grid power module;
performing a limiting step, wherein the power regulating module stops the fuel cell system from outputting power, allows the storage battery to supply power to the load, and allows the fuel cell system to output power only after the fuel cell system is loaded to a level sufficient to supply an amount of power required by the load; and
controlling an output of the fuel cell system, wherein the power regulating module controls the output of the fuel cell system such that an output of the backup power system responds to variation of the load in real time.

4. The control method of claim 3, wherein the step of controlling an output of the fuel cell system comprises the sub-steps of:
detecting the variation of the load to obtain a variation value;
performing a load shedding step, wherein, when the variation value is less than zero, the fuel cell system is load-shed to output power;
performing a controlling step which comprises: maintaining current power output from the fuel cell system when the variation value is larger than the default variation value; supplying power to the load by the storage battery; and supplying power to the load by the power regulating module only after the fuel cell system is loaded to the level sufficient to supply the amount of power required by the load; and
performing a monitoring step which comprises: monitoring the variation of the load continuously and calculating a cumulative variation value, when the variation value is positive and not larger than the default variation value; and maintaining the current power output from the fuel cell system, allowing the storage battery to supply power to the load, and allowing the power regulating module to supply power to the load only after the fuel cell system is loaded to the level sufficient to supply the amount of power required by the load, when the cumulative variation value is larger than the default variation value.

5. The control method of claim 4, wherein the power regulating module comprises a switched-mode power converter and a controller, the controller comprising a controlling unit, a counter, a computing unit, and a register, the limiting step being performed by the controller and comprising the sub-steps of:
stopping the power regulating module from outputting power, while supplying power by the storage battery;
counting a corresponding actuation time, wherein the counter counts an actuation time of the power regulating module;
computing a corresponding response time, wherein the computing unit computes the response time corresponding to the variation value;
comparing the actuation time with the response time, wherein the controlling unit compares the actuation time with the response time; and
supplying power by the power regulating module, wherein the fuel cell system outputs power through the power regulating module if the actuation time is longer than the response time.

6. The control method of claim 5, wherein the controlling step is performed by the controller and comprises the sub-steps of:
maintaining current output power of the power regulating module while supplying power to the load by the storage battery in an auxiliary manner;
counting corresponding said actuation time;
calculating corresponding said response time;
comparing the actuation time with the response time; and
boosting power supply of the power regulating module, wherein the fuel cell system outputs the amount of power required by the load through the power regulating module, if the actuation time is longer than the response time.

7. The control method of claim 6, wherein the monitoring step is performed by the controller and comprises the sub-steps of:
counting the cumulative variation value, wherein the cumulative variation value is defined as a cumulative variation percentage of the load;
storing the variation value into the register and calculating and storing corresponding said response time, when the cumulative variation value equals zero;
adding the variation value to the register and calculating and storing corresponding said response time, when the cumulative variation value is larger than zero;
counting corresponding said actuation time; and
comparing the actuation time with the response time, followed by performing the sub-steps of:
resetting the register and detecting the variation of the load, if the actuation time is longer than the response time;
detecting the variation of the load if the actuation time is shorter than the response time and the cumulative variation value is less than the default variation value; and
calculating a difference between the response time and the actuation time, substituting the difference for the response time computed in the controlling step, and then proceeding to the controlling step, if the actuation time is shorter than the response time and the cumulative variation value is larger than the default variation value.
